(19) United States
(12) Patent Application Publication
(10) Pub. No.: US 2025/0077138 A1
(43) Pub. Date: Mar. 6, 2025

(54) IMAGE FORMING APPARATUS, NON-TRANSITORY COMPUTER READABLE STORAGE MEDIUM STORING DRIVER PROGRAM, AND PRINTING METHOD

(71) Applicant: SHARP KABUSHIKI KAISHA, Osaka (JP)

(72) Inventor: Hiroyuki AOYAGI, Osaka (JP)

(21) Appl. No.: 18/809,626

(22) Filed: Aug. 20, 2024

(30) Foreign Application Priority Data
Sep. 1, 2023 (JP) 2023-142580

(51) Int. Cl. G06F 3/12

(52) U.S. Cl. CPC G06F 3/1222; G06F 3/1238; G06F 3/1253

(57) ABSTRACT

An image forming apparatus includes one or more controllers and an image former. When information for giving additional information to image information is included in print job data transmitted from an information processing device, the one or more controllers generate the additional information, and when the image information is image information related to a document that certifies authenticity of contents and a setting of the image forming apparatus satisfies a provision condition for giving the additional information, the one or more controllers control the image former to give the additional information to the image information and form an image.

### TECHNICAL FIELD

The disclosure relates to an image forming apparatus and the like.

### BACKGROUND ART

There is known a printing device capable of individually managing a medium on which an electronic document is printed and tracking later various kinds of information relating to the electronic document as well as various kinds of information obtained at the time of printing the electronic document.

### SUMMARY

### Technical Problem

An object of the disclosure is to provide an image forming apparatus and the like capable of performing appropriate output management of image information by performing control related to giving additional information to the image information.

### Solution to Problem

In order to solve the above issue, an image forming apparatus according to the disclosure includes one or more controllers and an image former. When information for giving additional information to image information is included in print job data transmitted from an information processing device, the one or more controllers generate the additional information, and when the image information is image information related to a document that certifies authenticity of contents and a setting of the image forming apparatus satisfies a provision condition for giving the additional information, the one or more controllers control the image former to give the additional information to the image information and form an image.

A non-transitory computer readable storage medium is a storage medium storing a driver program according to the disclosure for causing a computer to enable a function to display an input screen for receiving input of a print setting related to a print job, and a function to output print job data including information related to giving additional information to image information received from a user via the input screen and the image information.

A printing method according to the disclosure is a printing method in an image forming apparatus, the method including generating additional information when information for giving the additional information to image information is included in print job data, and forming an image by giving the additional information to the image information when the image information is image information related to a document that certifies authenticity of contents and a setting of the image forming apparatus satisfies a provision condition for giving the additional information.

### Advantageous Effects of Disclosure

According to the disclosure, it is possible to provide an image forming apparatus and the like capable of performing appropriate output management of image information by performing control related to giving additional information to the image information.

### BRIEF DESCRIPTION OF DRAWINGS

FIG. 1 is a diagram for explaining a connection mode of an image forming apparatus and an information processing device according to a first embodiment.

FIG. 2 is a diagram for explaining a functional configuration of the image forming apparatus according to the first embodiment.

FIG. 3 is a diagram for explaining additional information according to the first embodiment.

FIG. 4 is a diagram for explaining a functional configuration of the information processing device according to the first embodiment.

FIG. 5 is a flowchart for explaining a procedure according to the first embodiment.

FIG. 6 is a flowchart for explaining a procedure according to the first embodiment.

FIG. 7 is a diagram for explaining an operation example according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIG. 15 is a diagram for explaining an operation example according to the first embodiment.

FIG. 16 is a diagram for explaining a functional configuration of an image forming apparatus according to a second embodiment.

FIG. 17 is a diagram for explaining a functional configuration of an information processing device according to the second embodiment.

FIG. 18 is a flowchart for explaining a procedure according to the second embodiment.

FIG. 19 is a flowchart for explaining a procedure according to the second embodiment.

FIG. 20 is a diagram for explaining an operation example according to the second embodiment.

FIG. 21 is a diagram for explaining an operation example according to the second embodiment.

### DESCRIPTION OF EMBODIMENTS

Embodiments according to the disclosure will be described below with reference to the drawings. Note that the following embodiments are examples for explaining the disclosure, and the technical content of the explanation described in the claims is not limited to the following description.

There is known an image forming apparatus that outputs a code obtained by encoding various kinds of information with one or more of, for example, a two-dimensional code (quick response code: QR code (trade name)), a one-dimensional code (bar code), a sign, and an alphanumeric character as a printed matter together with a print image.

For example, the related art cited above describes a printing device that generates a code image as a code for printing from code information for uniquely identifying a medium on which an electronic document is printed, and prints the generated code image and a document image on the medium.

The printing device according to the related art is a device that enables individual management of a medium on which an electronic document is printed using a code image printed together with a document image, and tracks later various kinds of information related to the electronic document as well as various kinds of information obtained when the electronic document is printed.

However, in the related art, it is not possible to perform output management of a printed matter satisfying a security level required by a user, such as changing contents of various kinds of information represented by a code (code image) in accordance with an electronic document (document image) or giving a code only under a specific condition. In the related art cited above, necessary information for a code is input on a printer driver and whether the code can be given is determined based on the input information and a system setting, and in a case where the code cannot be given, it is not possible to notify the cause via the printer driver.

According to the disclosure, in the following embodiments, an image forming apparatus or the like capable of performing appropriate output management of image information is achieved by controlling the print of additional information with respect to the image information.

### 1. First Embodiment

### 1.1 Overall Configuration

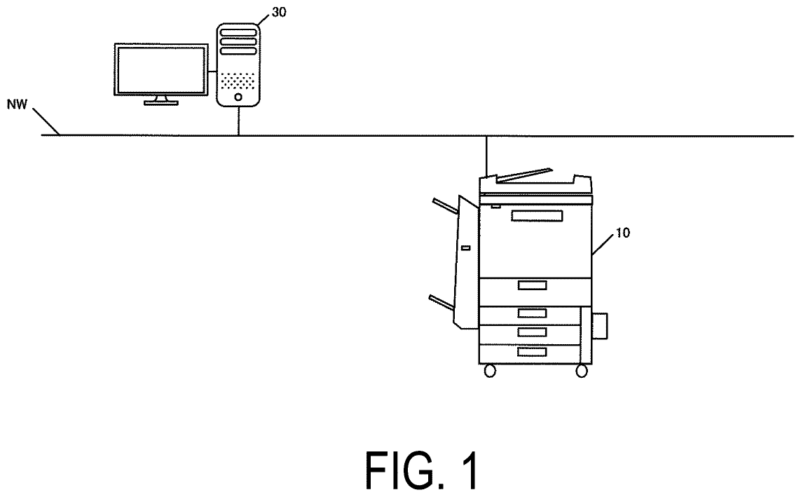

FIG. 1 is a diagram for explaining an example of a connection mode of a multifunction peripheral 10 as an image forming apparatus and a terminal device 30 as an information processing device according to a first embodiment.

The multifunction peripheral 10 is an example of an image forming apparatus that can execute various kinds of jobs such as print, copy, fax, and image transmission in one housing. Note that the image forming apparatus according to the disclosure is not limited to the multifunction peripheral 10, and may be an image forming apparatus specialized in a specific function such as a printer or a facsimile. As long as the multifunction peripheral 10 is so configured as to execute a job based on print job data received from the terminal device 30, the type, configuration, performance, and the like of the multifunction peripheral 10 are not limited. In the disclosure, a job for printing, on a medium, image information included in print job data or additional information (encoded information) given to the image information is referred to as a print job. The multifunction peripheral 10 is connected to a network NW in such a manner as to be able to communicate with the terminal device 30 and other devices (not illustrated). The multifunction peripheral 10 may be connected to another network NW (not illustrated) connected to the network NW, or a plurality of the multifunction peripherals 10 may be connected to the network NW.

The terminal device 30 can be configured as a computer that operates under control of a specific operating system (OS). The terminal device 30 is not limited to any of the device type, device configuration, device performance, and the like as long as the terminal device 30 is configured in such a manner as to be able to communicate with the multifunction peripheral 10 and transmit a generated print job to the multifunction peripheral 10 via a controller that operates as a printer driver to be described later (hereinafter, the controller that functions as a printer driver may be simply referred to as a printer driver). The terminal device 30 may be connected to another network NW (not illustrated) connected to the network NW, or a plurality of the terminal devices 30 may be connected to the network NW.

### 1.2 Functional Configuration

### 1.2.1 Multifunction Peripheral 10

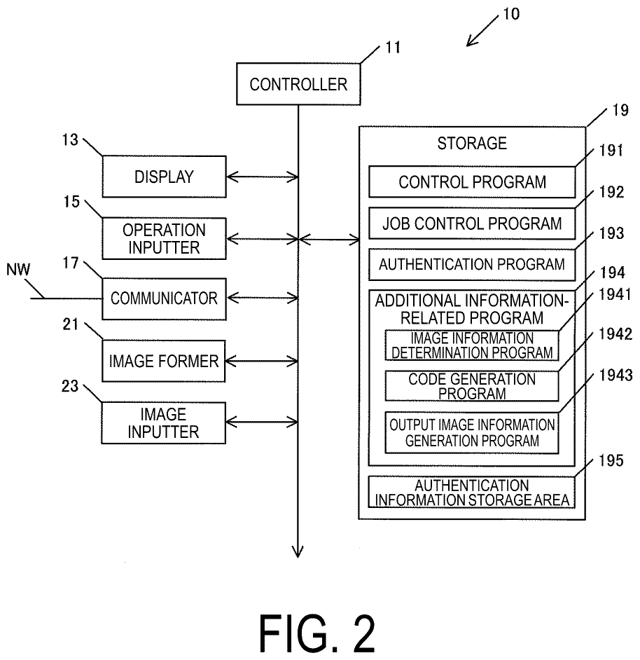

A functional configuration of the multifunction peripheral 10 will be described with reference to FIG. 2. FIG. 2 is a diagram for explaining the functional configuration of the multifunction peripheral 10. The multifunction peripheral 10 includes a controller 11, a display 13, an operation inputter 15, a communicator 17, a storage 19, an image former 21, and an image inputter 23.

The controller 11 controls the entire multifunction peripheral 10. The controller 11 is configured of, for example, one or multiple arithmetic devices (central processing unit (CPU), system on a chip (SoC), or the like). The controller 11 implements a function thereof by reading and executing various programs stored in the storage 19.

The display 13 is a display device that displays various types of information for a user or the like. The display 13 can be configured of, for example, a liquid crystal display (LCD) or an organic electro-luminescence (EL) display.

The operation inputter 15 is an input device that receives input of information by the user or the like. The operation inputter 15 can be configured of, for example, various input devices such as operation keys (for example, hardware keys and software keys) and buttons. The operation inputter 15 can be configured as a touch panel that enables input via the display 13. In this case, as an input method for the touch panel, for example, a general method such as a resistance film method, an infrared beam method, an electromagnetic induction method, or an electrostatic capacitance method can be employed.

The communicator 17 includes, for example, one or both of wired and wireless interfaces for communication with another device (terminal device 30) via the network NW such as a local area network (LAN), a wide area network (WAN), the Internet, a telephone line, or a fax line. In addition, the communicator 17 may include an interface related to a (short-range) wireless communication technology such as Bluetooth (trade name), near-field communication (NFC), Wi-Fi (trade name), ZigBee (trade name), Infrared Data Association (IrDA), or a wireless USB.

The image former 21 feeds a sheet from a feed tray (not illustrated), prints image information and an image of a code related to additional information that are included in a print job, and then discharges the sheet to a paper discharger (not illustrated). The image former 21 may be configured of, for example, a laser printer using an electrophotographic system. In this case, the image former 21 performs printing while using toner supplied from toner cartridges (not illustrated) corresponding to toner colors (for example, cyan, magenta, yellow, and black).

The image inputter 23 generates image information by scanning a document. The image inputter 23 can be configured as a scanner device that is provided with an image sensor such as a charge coupled device (CCD) or a contact image sensor (CIS) and that includes an automatic document feeder (ADF), a flatbed on which a document is set to be read, and the like. The configuration of the image inputter 23 is not particularly limited as long as the image inputter 23 can generate image information by reading a reflected light image from a document image using the image sensor. The image inputter 23 also can be configured as an interface that can acquire, for example, document information stored in an external storage medium such as a universal serial bus (USB) memory and image information included in a print job transmitted from the terminal device 30.

The storage 19 is constituted of one or more storage devices and stores various programs and various types of data necessary for the operation of the multifunction peripheral 10. The storage 19 may be constituted by, for example, a storage device such as a random access memory (RAM), a hard disk drive (HDD), a solid state drive (SSD), or a read only memory (ROM).

In the first embodiment, the storage 19 stores a control program 191, a job control program 192, an authentication program 193, and an additional information-related program 194, and secures an authentication information storage area 195.

The control program 191 is a program read by the controller 11 when the controller 11 performs centralized control of the multifunction peripheral 10. The controller 11, after reading out the control program 191, controls driving of hardware such as the display 13, the operation inputter 15, the communicator 17, the image former 21, and the image inputter 23.

The job control program 192 is a program to be read out by the controller 11 when executing a job such as print (including print hold), copy, fax, or image transmission. When the controller 11 has read out the job control program 192, it shifts to a job mode (a print (copy) mode, a fax mode, an image transmission mode, or the like) for executing each job, and then executes the corresponding job. When a job is to be executed, the controller 11 displays an execution screen on the touch panel configured as the operation inputter 15 (display 13). The execution screen receives a setting value, a function selection, or the like necessary for executing the job from the user as needed. The controller 11 can process a job based on a setting value, a function selection, or the like received via the execution screen, a job received from another device such as the terminal device 30, and the like.

The print hold is one of print functions in which image information acquired as a print job is temporarily held in the storage 19 and printing is performed based on an operation command from a user. In this case, a preview image having been generated based on the held image information (including a code related to additional information when the additional information is given) is displayed on the touch panel, thereby making it possible to check a print result before printing.

The authentication program 193 is a program that is read out by the controller 11 when a user who attempts to log into the multifunction peripheral 10 is authenticated. After reading out the authentication program 193, the controller 11 operates as an authenticator that operates based on a user authentication function, and causes a login screen (not illustrated) to be displayed on the touch panel and then receives input by the user of authentication information related to the user authentication when the user authentication function is enabled. For example, in a case where the authentication condition is a combination of a login user name and a login password, the controller 11 can perform user authentication by storing login user names and login passwords related to the user authentication in association with each other in advance and checking the login user name and the login password input via the login screen against the stored login user names and login passwords. The user authentication may be, for example, possession-based authentication using a token, a key, an integrated circuit (IC) card or a smartphone, or biometric authentication such as face authentication or fingerprint authentication, in addition to knowledge-based authentication combining a login user name and a login password. The controller 11 can receive a setting of enabling/disabling the user authentication function from an administrator having administrative privileges via a system setting screen to be described later or the like. The controller 11, after reading out the authentication program 193, can transmit, to the terminal device 30, a response to an inquiry about whether the user authentication function is enabled or disabled from the terminal device 30 or a user authentication result based on the authentication information transmitted from a printer driver of the terminal device 30 when the user authentication function is enabled.

The additional information-related program 194 is a program that is read out by the controller 11 when the communication with the terminal device 30 is started and a print job transmitted from the printer driver of the terminal device 30 is received. When the controller 11, after reading out the additional information-related program 194, determines that necessary information is included in the print job transmitted from the printer driver, the controller 11 considers that a command for giving additional information to the image information is issued, and executes processing related to the giving of the additional information. Here, the additional information according to the disclosure is information that is given to the image information related to the print job, includes specific information described below, and is converted into encoded information (image) by encoding. The necessary information is such information that includes the authentication information and part or all of the specific information, and is necessary for determining whether to give the additional information to the image information.

The controller 11, after reading out the additional information-related program 194, performs processing related to the following items as an example of processing for determining whether additional information can be given.
(1) Examination of acquired necessary information
(2) Check of system setting
(3) Check of user authentication result
(4) Check of presence or absence of print setting by unauthorized user

Then, by verifying the necessary information input by the user, the system setting content of the device, the user authentication result, or the presence or absence of the print setting by the unauthorized user, it is determined whether a provision condition related to giving the additional information is satisfied. In a case where it is determined that the provision condition is satisfied, the controller 11 progresses a generation process of output image information to be described later, such as the generation of encoded information related to the additional information. On the other hand, when it is determined that the provision condition is not satisfied, the controller 11 notifies the printer driver of the terminal device 30 of an error factor.

The above-discussed additional information-related program 194 includes an image information determination program 1941, a code generation program 1942, and an output image information generation program 1943. The controller 11, after reading out the image information determination program 1941, determines whether the type of the image information related to the print job is image information of a document that certifies the authenticity of the contents. Here, the document that certifies the authenticity of the contents is a kind of document utilized inside or outside an organization to which the user who executes the print job belongs, and refers to an official document (hereinafter, referred to as an official document in the disclosure) which has been approved by a plurality of administrators as necessary with respect to the document created by the user. On the other hand, in a case where it is determined that the type of the image information related to the print is not a document that certifies the authenticity of the contents, the controller 11 determines the above image information as image information related to another document (hereinafter referred to as a non-official document (general job) in the disclosure) different from the document that certifies the authenticity of the contents. The controller 11, after reading out the image information determination program 1941, can determine the type of the image information related to the received print job based on the content of the necessary information, an identifier representing the type of the image information (for example, numerical values or characters such as “1” or “Yes” in the case of an official document and “0” or “No” in the case of a non-official document), or the like.

The code generation program 1942 is a program that is read out by the controller 11 when generating a code related to additional information. When the type of the image information related to the print is image information related to an official document, the controller 11, after reading out the code generation program 1942, takes specific information including organization information regarding an organization to which the user who executes the print job belongs as additional information, and generates image information (encoded information) of a code related to the additional information. On the other hand, when the type of the image information related to the print is image information related to a non-official document, job information regarding the print job and specific information including device information of the multifunction peripheral 10 are taken as additional information, and image information (encoded information) of a code related to the additional information is generated. The encoded information may be a one-dimensional code such as a barcode (for example, EAN code, JAN code, Codbar, CODE128, or the like) or may be a two-dimensional code. The two-dimensional code may be a stack type two-dimensional code (for example, PDF417, CODE49, or the like) or a matrix type two-dimensional code (for example, a quick response code (QR code (trade name)), DataMatrix, VeriCode, or Aztec). In the following description, a quick response code (QR code (trade name)) will be described as an example of encoded information.

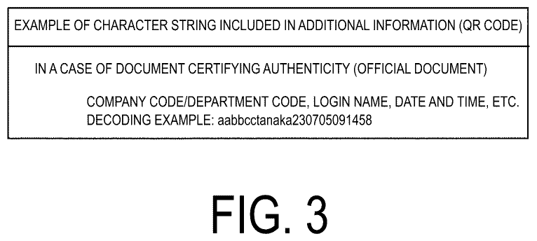

Here, with reference to FIG. 3, specific information given as additional information when the type of image information related to print is image information related to an official document will be described.

As exemplified in FIG. 3, when the type of the image information is an official document, examples of the specific information that is given as additional information to the image information to be printed include organization information regarding an organization to which a user who executes a print job belongs, such as a company code/department code. In addition, the specific information may include login information such as a login name of a user who has logged into the multifunction peripheral 10, and information regarding date and time information or the like such as a date and time of print. The organization information is not limited to a company code/department code, and is not particularly limited as long as the organization information is information that can specify a company (name) such as a company (firm) name, a company group name, a branch office (branch) name, a store name, a uniform resource locator (URL), a domain name or a contact address such as a telephone number, or specify a department of the organization to which a user who executes the print job belongs.

When the type of the image information is a non-official document, examples of the specific information that is given as additional information to the image information to be printed include job information regarding a print job such as a job mode and a job ID, and device information of the multifunction peripheral 10 such as a multifunction peripheral/printer (MPF) serial number. In addition, the job specific information may include login information such as a login name of a user that has logged into the multifunction peripheral 10, and information regarding date and time information such as the date and time of print. The job information is not limited to a job mode and a job ID. For example, in the case where the job is a print job, the job information is not particularly limited as long as the job information is information regarding a specific setting value related to the execution of the print job such as the number of print sheets or a color mode/monochrome mode. Alternatively, in the case where the print job to be executed is a print job utilizing a setting history of a print job having been executed, the job information is not particularly limited as long as the job information is information regarding the job to be executed such as the setting history ID for specifying the above setting history.

FIG. 3 also illustrates an example of specific information decoded by reading an image obtained by encoding the specific information with a reading device such as a code reader.

A decoding example in the case of an official document (specific information) is a character string including “aabbcc” as a company code/department code, “tanaka” as a login name, and “230705091458” (2023/07/05 09:14:58) as a date and time. With respect to the decoding of a code related to an official document, in consideration of security against a third party, it is preferable that character strings representing the company code/department code, the login name, the date and time, and the like be connected and represented without any delimiter (for example, an underscore) so as to make it difficult to recognize the decoded result at a glance. On the other hand, with respect to the decoding of a code related to a non-official document, in consideration of convenience of a (login) user, it is preferable that character strings representing the job mode, the MFP serial number, the job ID, the login name, the date and time, and the like be connected and represented using delimiters so as to make it easy to recognize the decoded result at a glance.

Referring back to FIG. 2, the output image information generation program 1943 is a program that is read out by the controller 11 when generating output image information to be printed on a medium by combining image information related to a print job and encoded information generated by reading out the code generation program 1942. The controller 11, after reading out the output image information generation program 1943, generates output image information in consideration of the print layout on the medium. For example, a code related to additional information can be given together with another image (for example, a watermark, a stamp, or a date stamp). However, when a print position (display position) related to the image of the code and a print position (display position) related to the image based on another display information overlap each other, the code related to the additional information can be preferentially printed. In this case, the controller 11 can perform adjustment in such a manner that the print position of the code related to the additional information does not overlap with the print position of another image by restricting the print of the other image or changing the print position of the other image. The print position of the code related to the additional information is preferably set to the upper right of the image forming surface of the medium so as not to affect the print of the image information related to the print job. However, the print position of the code related to the additional information can be appropriately changed and set by the user. When a certain kind of image has already been printed at the print position of the code related to the additional information, the controller 11 may overwrite the above image with the image of the code related to the additional information. When the necessary information is not included in the print job transmitted from the printer driver, that is, when a command for giving additional information to the image information related to the print job has not been issued, the controller 11, after reading out the output image information generation program 1943, generates output image information for printing with only the image information related to the print job. Then, the controller 11, after having generated the output image information, shifts to a job mode for executing the print job and executes the print job by reading out the job control program 192.

The authentication information storage area 195 is a storage area that stores authentication information of a user who attempts to log into the multifunction peripheral 10 (for example, a combination of a login user name and a login password related to user authentication). The controller 11, after reading out the authentication program 193, performs a user authentication process by comparing the authentication information related to a login user name and a login password received via a login screen (not illustrated) or the printer driver of the terminal device 30 with the authentication information read out from the authentication information storage area 195.

### 1.2.2 Terminal Device 30

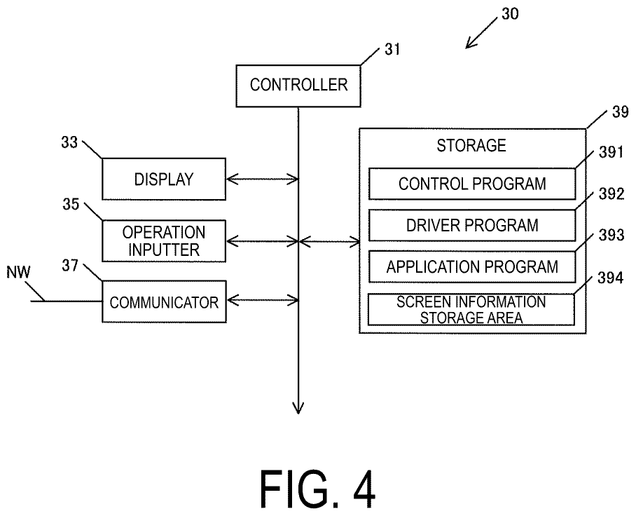

A functional configuration of the terminal device 30 will be described. FIG. 4 is a diagram for explaining the functional configuration of the terminal device 30. The terminal device 30 includes a controller 31, a display 33, an operation inputter 35, a communicator 37, and a storage 39.

The controller 31 controls the entire terminal device 30. The controller 31 is configured of, for example, one or multiple arithmetic devices (CPU, SoC, or the like). The controller 31 implements its function by reading and executing various programs stored in the storage 39.

The display 33 is a display device that displays various types of information for a user or the like. The display 33 can be configured of, for example, an LCD or an organic EL display.

The operation inputter 35 is an input device that receives input of information by the user or the like. As the operation inputter 35, an input device such as a keyboard, a mouse, or a touch panel can be used.

The communicator 37 includes one or both of wired and wireless interfaces for performing communication with another device (e.g., the multifunction peripheral 10) via, for example, a LAN, a WAN, the Internet, or a telephone line. Note that the communicator 37 may include an interface related to a (short-range) wireless communication technology such as Bluetooth (trade name), Wi-Fi (trade name), ZigBee (trade name), IrDA, or wireless USB.

The storage 39 is constituted of one or more storage devices and stores various programs and various types of data necessary for the operation of the terminal device 30. The storage 39 can be configured of a storage device such as a RAM, an HDD, an SSD, or a ROM.

In the first embodiment, the storage 39 stores a control program 391, a driver program 392, and an application program 393, and secures a screen information storage area 394.

The control program 391 is a program that is read out by the controller 31 when performing centralized control of the terminal device 30. The controller 31, after reading out the control program 391, functions as an OS, and, for example, controls driving of hardware such as the display 33, the operation inputter 35, and the communicator 37, activates and terminates an application driven on the OS, and manages files.

The driver program 392 is a printer driver that operates on the OS. The driver program 392 is a program that is read out by the controller 31 when transferring/receiving a print job with the multifunction peripheral 10 via the application. After reading out the driver program 392, the controller 31 functions as the printer driver. When a print command for an official document or a non-official document is received via the application, the printer driver displays a print execution screen described below for printing the above document on the display 33. The print execution screen is an input screen for receiving input of a print setting (also referred to as a setting for printing) related to a print job. The printer driver generates a print job based on the print setting received from the user via the print execution screen and transmits the generated print job to the multifunction peripheral 10. When the printer driver receives a notification of an error factor from the multifunction peripheral 10, the printer driver may display a notification screen related to the error factor on the display 33 (print execution screen) to prompt the user to resolve the error factor.

The application program 393 is a program that the controller 31 reads out upon receiving an activation command from the user. The controller 31, after reading out the application program 393, functions as the application, and provides specific functions in response to the purpose of the user, such as document generation of an official document, a non-official document or the like, graphic rendering, and Internet browsing. The application program 393 can be acquired by installation using a recording medium such as a CD or a DVD, downloading from a service providing server (not illustrated), or the like.

The screen information storage area 394 is a storage area that stores screen information (image/screen content) for configuring a setting screen for receiving a selection of the multifunction peripheral 10 to execute a print job, a print execution screen corresponding to the printer driver, and the like.

### 1.3 Procedure

### 1.3.1 Procedure of Multifunction Peripheral 10

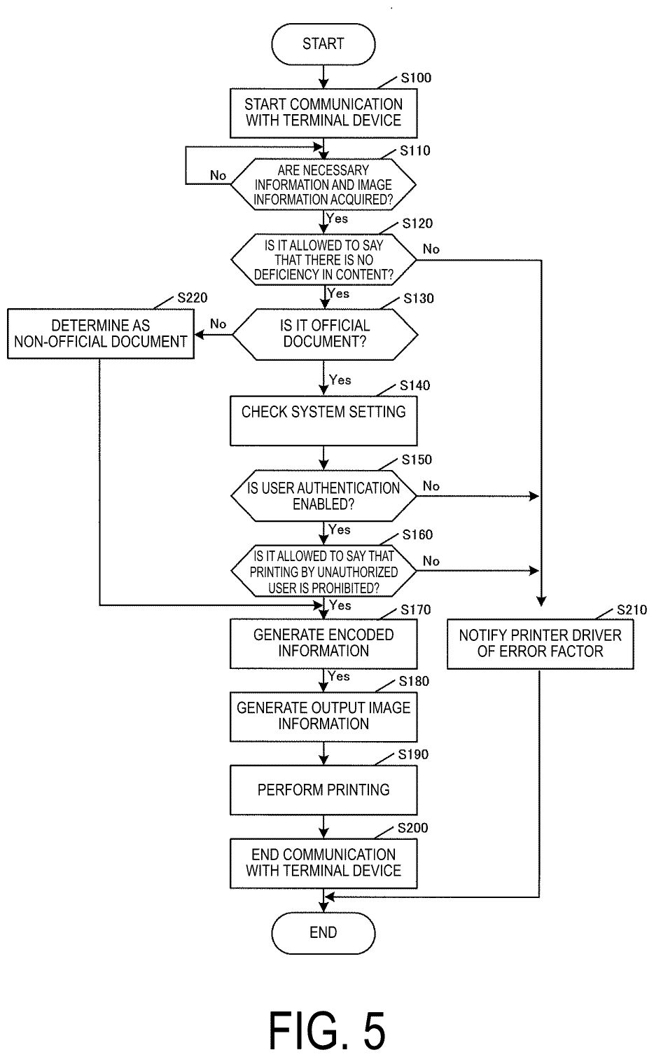

Next, a procedure according to the first embodiment will be described with reference to a flowchart illustrated in FIG. 5. FIG. 5 is a diagram illustrating a process in which the multifunction peripheral 10 starts communication with the terminal device 30, executes a print job, and ends the communication with the terminal device 30. In particular, the controller 11 of the multifunction peripheral 10 reads out the job control program 192, the authentication program 193, the additional information-related program 194, and the like, thereby executing the process explained in FIG. 5.

For example, the controller 11 of the multifunction peripheral 10 starts the communication with the terminal device 30 by taking the start of activating the printer driver of the terminal device 30, for example, as a trigger (step S100).

When a print job is received from the terminal device 30, the controller 11, which has started the communication with the terminal device 30, determines whether necessary information and image information have been acquired together with the print job (proceed from step S100 to step S110). When it is determined that the necessary information and the image information have been acquired, the controller 11 examines the acquired necessary information and determines whether there is any deficiency in the content (step S110; Yes, then proceed to step S120). On the other hand, when none of the necessary information and the image information have been acquired, the controller 11 stands by until the necessary information and the image information are acquired (step S110; No).

When it is determined that there is no deficiency in the necessary information, the controller 11 determines whether the type of the image information related to the print job is an official document (step S120; Yes, then proceed to step S130). When it is determined that the type of the image information related to the print job is an official document, the controller 11 causes the process to proceed to step S140 (step S130; Yes, then proceed to step S140). On the other hand, when it is determined that the type of the image information related to the print job is not an official document, the controller 11 determines the type of the image information related to the print job as a non-official document, and causes the process to proceed to step S170 without checking a setting content of the system setting of the own device (step S130; No, then proceed to step S220 and to step S170).

In step S140, the controller 11 checks the setting content of the system setting of the own device. For example, the controller 11 checks the setting content of a QR code print setting for receiving a setting of whether to give a code (QR code) as additional information to the image related to the image information of the print job to be executed in the own device. Even if the setting content of the own device is a setting for not giving a code as additional information (for example, “not print”), the controller 11 determines that a code as additional information is given to the image while ignoring the setting content of the own device when the type of the image information related to the print job is an official document and a code provision condition based on the necessary information is satisfied.

Subsequently, the controller 11 determines whether a user authentication function is enabled and the user authentication based on the authentication information included in the necessary information is successful (proceed from step S140 to step S150). When it is determined that the user authentication function is enabled and the user authentication based on the authentication information included in the necessary information is successful, the controller 11 causes the process to proceed to step S160 (step S150; Yes, then proceed to step S160).

In step S160, the controller 11 determines whether a function of prohibiting print by an unauthorized user is set. The function of prohibiting print by an unauthorized user refers to a setting for restricting the print by an unauthorized user (for example, a guest user) who is not granted (user) authentication with respect to the multifunction peripheral 10. When it is determined that the function of prohibiting print by an unauthorized user is set, the controller 11 generates encoded information based on the necessary information (specific information) (step S160; Yes, then proceed to step S170).

The controller 11 combines the encoded information generated in step S170 with the image information related to the print job acquired in step S110, thereby generating output image information (step S180). Then, the controller 11 executes printing based on the generated output image information (step S190). After executing the printing, the controller 11 ends the communication with the terminal device 30 and ends the process (step S200).

When it is determined that there is a deficiency in the necessary information (step S120; No), when it is determined that the user authentication based on the authentication information included in the necessary information fails even if the user authentication function is disabled or enabled (step S150; No), or when it is determined that the function of prohibiting print by an unauthorized user is not set (step S160; No), the controller 11 notifies a printer driver of the multifunction peripheral 10 of an error factor and ends the process (step S210).

### 1.3.2 Procedure of Terminal Device 30

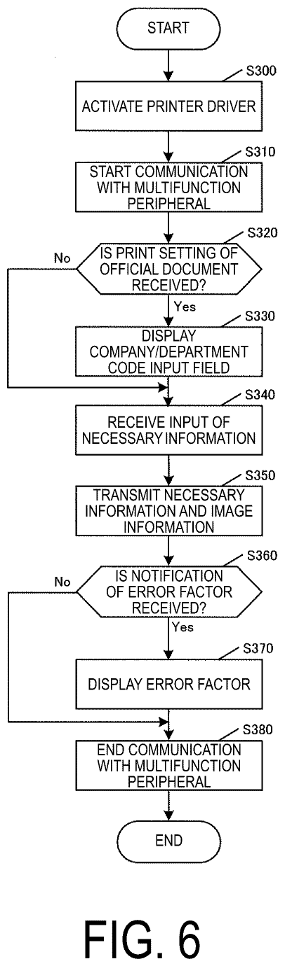

FIG. 6 is a diagram for explaining a process from when the printer driver of the terminal device 30 is activated to when the communication with the multifunction peripheral 10 is ended. In particular, the controller 31 of the terminal device 30 executes the process described in FIG. 6 by reading out the driver program 392, the application program 393, and the like.

For example, when the controller 31 of the terminal device 30 receives a command for printing an object via the application from a user, the controller 31 reads out the driver program 392, thereby being activated as the printer driver (step S300). The controller 31 activated as the printer driver (hereinafter, referred to as the printer driver) displays a print execution screen on the display 33 and starts the communication with the multifunction peripheral 10 (step S310).

Subsequently, the printer driver determines whether the print setting received via the print execution screen is a print setting related to an official document (step S320). When it is determined that the received print setting is a print setting related to an official document, the printer driver displays an input field of a company/department code as specific information related to the official document (step S320; Yes, then proceed to step S330). On the other hand, when it is determined that the received print setting is not a print setting related to an official document, the printer driver causes the process to proceed to step S340 (step S320; No, then proceed to step S340).

The printer driver receives input of necessary information (step S340). Then, the printer driver transmits the input necessary information and image information related to print to the multifunction peripheral 10 (step S350). After transmitting the necessary information and the image information, the printer driver determines whether a notification of an error factor has been received from the multifunction peripheral 10 (step S360).

When it is determined that a notification of an error factor has not been received from the multifunction peripheral 10, the printer driver ends the communication with the multifunction peripheral 10 and ends the process (step S360; No, then proceed to step S380).

On the other hand, when it is determined that a notification of an error factor has been received from the multifunction peripheral 10, the printer driver displays the notified error factor on the print execution screen (display 33) (step S360; Yes, then proceed to step S370). Then, the printer driver ends the communication with the multifunction peripheral 10 and ends the process (step S380). A mode in which the necessary information and the image information are simultaneously transmitted as a print job to the multifunction peripheral 10 is described in FIG. 6. However, the necessary information may be transmitted to the multifunction peripheral 10 first, and the image information may be transmitted thereto when no deficiency is found in the necessary information.

### 1.3 Operation Examples

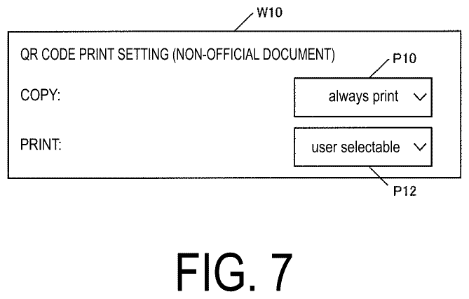

Next, operation examples according to the first embodiment will be described. FIG. 7 is a configuration example of a QR code print setting screen W10 for receiving a setting of whether to give a code (QR code) as additional information to an image related to image information of a print job to be executed. The QR code print setting screen W10 can be displayed via the system setting screen or the like of the multifunction peripheral 10.

The QR code print setting screen W10 exemplified in FIG. 7 relates to printing of image information (non-official document) related to a copy job or a print job, and includes a pull-down menu P10 and a pull-down menu P12 for receiving a selection of whether to give a QR code to an image related to the image information. In the pull-down menus exemplified by the pull-down menu P10 and the pull-down menu P12, any of the menus “always print”, “user selectable”, and “not print” as items selectable by the user can be selected.

When a job to be executed is a copy job, the pull-down menu P10 is a pull-down menu for receiving a selection of whether to give a QR code to an image related to image information of the copy job. When a job to be executed is a print job, the pull-down menu P12 is a pull-down menu for receiving a selection of whether to give a QR code to an image related to image information of the print job. In the multifunction peripheral 10 according to the first embodiment, it is possible to select a mode of giving a QR code in accordance with the type of the job.

For example, the menu “always print” indicated in the pull-down menu P10 refers to a mode in which a QR code is always given regardless of the selection by the user. On the other hand, the menu “user selectable” indicated in the pull-down menu P12 refers to a mode in which the user can select whether to give a QR code via the (job) execution screen of the multifunction peripheral 10. Although not illustrated, the menu “not print” refers to a mode of restricting the giving of a QR code regardless of the type of job to be executed. In the multifunction peripheral 10 according to the first embodiment, even if the setting content of the own device is a setting for not giving a QR code as additional information (“not print”), the controller 11 gives a QR code as additional information to the image related to the image information while ignoring the setting content of the own device when the type of the image information related to the print job is an official document and a code provision condition based on the necessary information is satisfied.

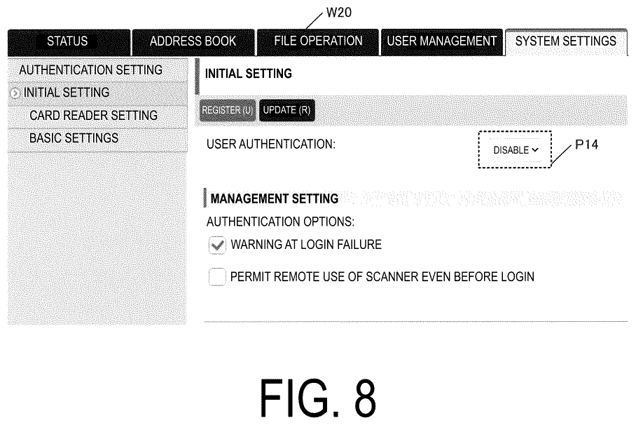

FIG. 8 is an example of an initial setting screen W20 provided with a user authentication pull-down menu P14 for receiving a setting of enabling/disabling the user authentication function. The initial setting screen W20 can be displayed via the system setting screen or the like of the multifunction peripheral 10. The administrator having the administrative privileges over the multifunction peripheral 10 can switch the setting between enabling and disabling the user authentication function via a user authentication pull-down menu P14 on the initial setting screen W20.

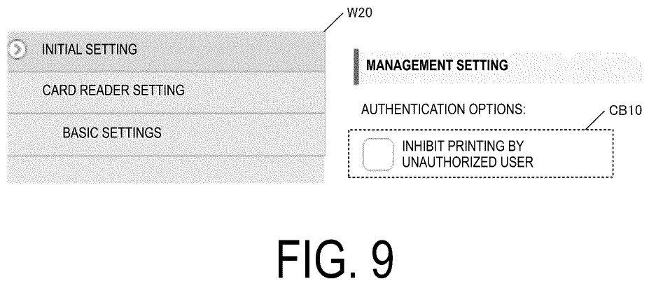

FIG. 9 is an example of the initial setting screen W20 provided with an unauthorized user print prohibition check box CB10 for receiving a setting of a print prohibition function against unauthorized users. The administrator can switch the setting between enabling and disabling the print prohibition function against unauthorized users via the unauthorized user print prohibition check box CB10 on the initial setting screen W20.

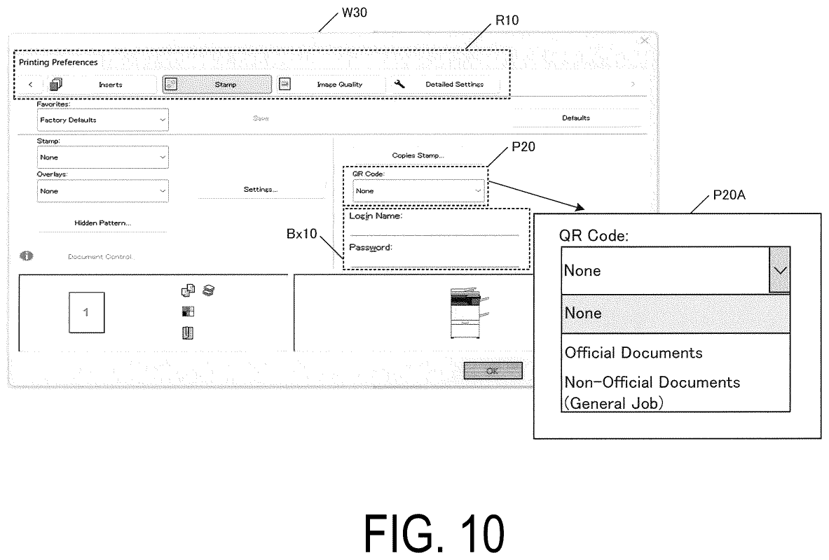

FIG. 10 is a configuration example of a print execution screen W30 as an input screen displayed by the printer driver of the terminal device 30. The print execution screen W30 is an execution screen displayed by the printer driver when a print command is received via a predetermined application in the terminal device 30. In the case of a print job, a target to which a QR code is given as additional information is image information related to a print target image generated via a predetermined application. In FIG. 10, an aspect in which a QR code is given to the image information via the print execution screen W30 is described.

The print execution screen W30 includes a print setting area R10. The print execution screen W30 in FIG. 10 is an example in which print settings selectable by the user that include insert print (“Inserts”), “Stamp”, “Image Quality”, and “Detailed Settings” are provided in the print setting area R10. In the print setting area R10, the user can perform print setting in accordance with the displayed setting content with regard to any of the settings of insertion print, stamp, image quality, and detailed settings.

FIG. 10 illustrates an example in which the setting related to giving a QR code is provided in the print setting related to the stamp. In FIG. 10, the setting related to giving a QR code is provided in the print setting related to the stamp, but the setting related to giving a QR code can be provided in another print setting such as the detailed settings.

In this case, a QR code-giving target selection pull-down menu P20 is a pull-down menu for receiving a selection of a document type to which a QR code is given as additional information. FIG. 10 illustrates an example in which a document to be given with a QR code is not selected (None). The QR code-giving target selection pull-down menu P20 can display a selection screen in which a display area is developed downward in the drawing by a click operation on a downward arrow, or the like. In a development screen P20A, “None” (no selection), “Official Documents”, and “Non-Official Documents (General Job)” are displayed as items that can be selected by the user. By selecting a desired item, the user can set the target to be given with a QR code to any of “None”, “Official Documents”, and “Non-Official Documents (General Job)”.

An authentication information input box Bx10 is an input box for receiving input of user authentication information with respect to the multifunction peripheral 10. When a login user name (Login Name) and a login password (Password) are input by the user as authentication information, the printer driver transmits the input authentication information to the multifunction peripheral 10 as necessary information.

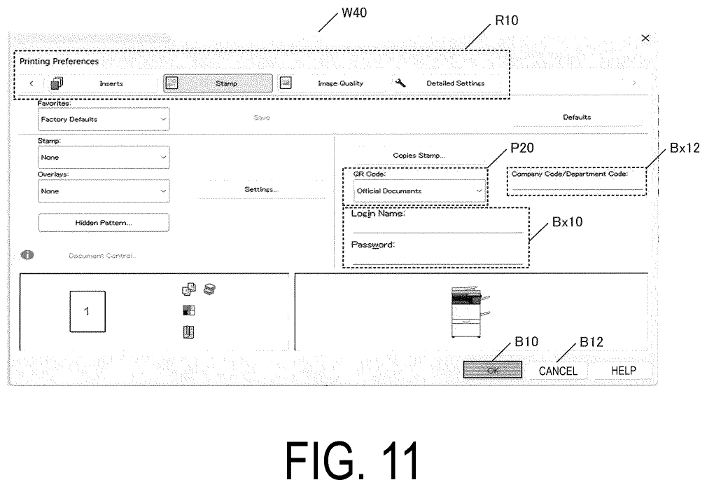

FIG. 11 is an example of a screen transition in a case where “Official Documents” is selected as a document type to be given with a QR code via the QR code-giving target selection pull-down menu P20 on the print execution screen W30 exemplified in FIG. 10.

A print execution screen W40 exemplified in FIG. 11 includes a specific information input box Bx12 in addition to the configuration of the print execution screen W30. The specific information input box Bx12 is a box for receiving input of organization information as an example of specific information. The specific information input box Bx12 is an input box displayed when an official document is selected as the document type to be given with a QR code in the QR code-giving target selection pull-down menu P20. FIG. 11 is an example of an input box for receiving input of “Company Code/Department Code” as organization information. The user can include the input organization information in the additional information by inputting a company code/department code such as “aabbcc” (see FIG. 3).

An OK button B10 as an input confirmation button is a button for receiving a confirmation command with respect to the selection and input contents on the print execution screen W40. A cancel button B12 is a button for receiving a command for canceling the selection and input contents on the print execution screen W40. Until the input of necessary information of the QR code-giving target selection pull-down menu P20, the specific information input box Bx12, the authentication information input box Bx10, and the like is completed, the OK button B10 is preferably not selectable by being displayed in a gray-out state as exemplified in FIG. 11 or being not displayed until the input of the necessary information has been completed.

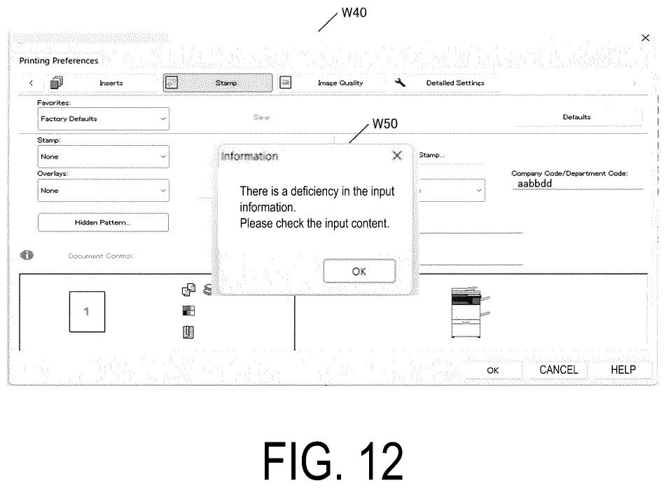

FIG. 12 is a diagram for explaining a notification example of an error factor notified to the printer driver when the controller 11 of the multifunction peripheral 10 determines that there is a deficiency in the necessary information in step S120 of FIG. 5.

FIG. 12 is an example in which an error factor notification screen W50 taking a message of “There is a deficiency in the input information. Please check the input content.” as a notification content of the error factor is displayed superimposed on the print execution screen W40. By checking the error factor notification screen W50, the user can understand that there is a deficiency in the input of the necessary information.

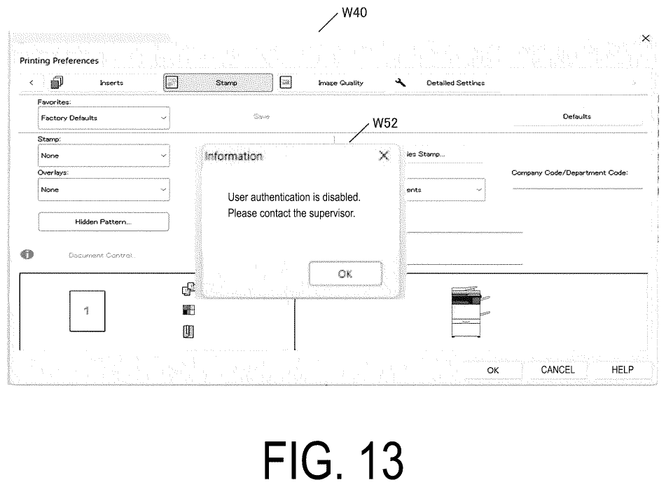

FIG. 13 is a diagram for explaining a notification example of an error factor notified to the printer driver when the controller 11 of the multifunction peripheral 10 determines that the user authentication function is not enabled in step S140 of FIG. 5.

FIG. 13 is an example in which an error factor notification screen W52 taking a message of “User authentication is disabled.” as a notification content of the error factor is displayed superimposed on the print execution screen W40. By checking the error factor notification screen W52, the user can understand that the user authentication function of the multifunction peripheral 10 is disabled and the contact with the administrator is needed.

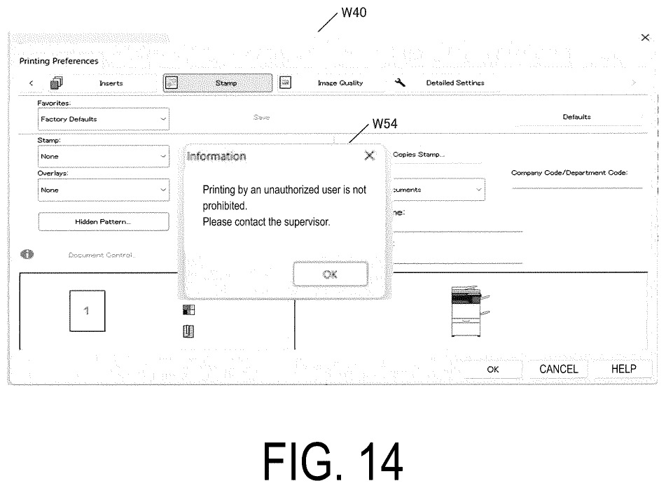

FIG. 14 is a diagram for explaining a notification example of an error factor notified to the printer driver when the controller 11 of the multifunction peripheral 10 determines that the function of inhibiting print by an unauthorized user is not enabled in step S150 of FIG. 5.

FIG. 14 is an example in which an error factor notification screen W54 taking a message of “Printing by an unauthorized user is not prohibited.” as a notification content of the error factor is displayed superimposed on the print execution screen W40. By checking the error factor notification screen W54, the user can understand that the function of prohibiting print by an unauthorized user of the multifunction peripheral 10 is disabled and the contact with the administrator is needed.

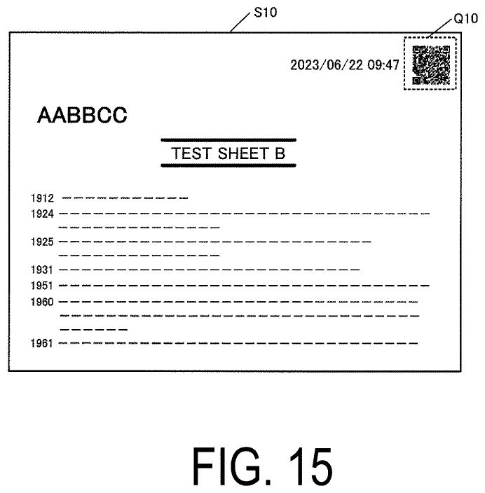

FIG. 15 is a diagram for explaining an example of a print result of an official document to which a QR code is given as additional information. In FIG. 15, in addition to the official document text as image information related to the print job, a QR code Q10 is printed on the upper right corner of a medium S10. The print position of the QR code Q10 is preferably the upper right corner of the medium so as not to affect the readability of the official document text, but the print position is not limited thereto. In addition to four corners of the upper right, upper left, lower right, and lower left of the medium, the QR code Q10 can be printed on a rear side of the print face for the official document text in a case where the device configuration is capable of double-sided printing. The print position of the QR code Q10 can be optionally set or changed by the user. Although a print size of the QR code Q10 can be optionally set, it is preferable that the print size be fixed regardless of the medium size in consideration of reading performance of a reading device such as a code reader.

As described above, in the first embodiment, when the provision condition based on the necessary information is satisfied as a specific condition in a print job transmitted from the printer driver, it is possible to execute the printing of the image in which a code as additional information is given to the image information related to the print job. When the provision condition is not satisfied, an error factor is notified from the multifunction peripheral. Therefore, the user who operates the printer driver via the terminal device can easily grasp the error factor, and can appropriately deal with the error factor.

### 2. Second Embodiment

A mode of a second embodiment is such that when a provision condition based on necessary information is not satisfied in the first embodiment, a permission request for resolving an error factor is made with respect to the multifunction peripheral 10 based on a command from a user.

Since the overall configuration according to the second embodiment is similar to that of the first embodiment, description thereof will be omitted here.

### 2.1 Functional Configuration

### 2.1.1 Multifunction Peripheral 50

A functional configuration of a multifunction peripheral 50 according to the second embodiment can be made substantially similar to the functional configuration of the multifunction peripheral 10 according to the first embodiment. Accordingly, the same functional configuration elements as those of the multifunction peripheral 10 are denoted by the same reference signs and description thereof will be omitted, and different elements will be described.

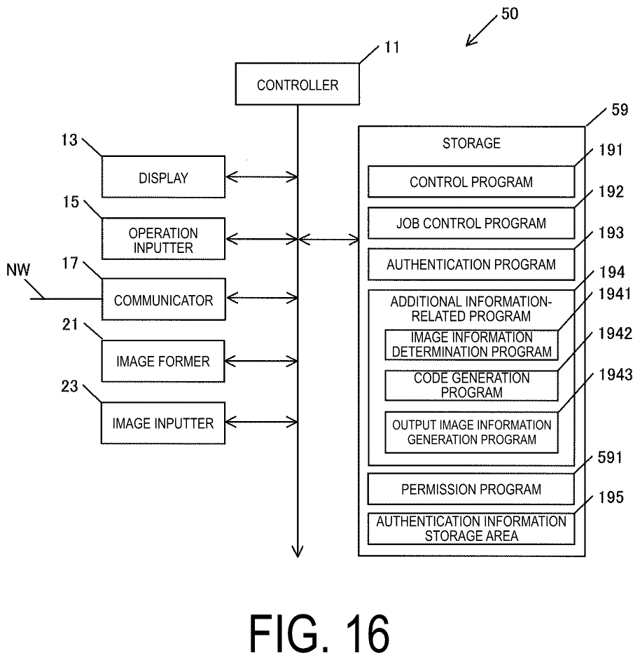

FIG. 16 is a diagram for explaining the functional configuration of the multifunction peripheral 50. The multifunction peripheral 50 includes a storage 59 instead of the storage 19 of the multifunction peripheral 10.

The storage 59 includes a permission program 591 in addition to the configuration of the storage 19. The permission program 591 is a program that is read out by a controller 11 when a permission request is received from a printer driver. The controller 11, after reading out the permission program 591, functions as a permitter, and performs a permission process related to the resolution of an error factor notified to the printer driver by the multifunction peripheral 50.

### 2.1.2 Terminal Device 70

A functional configuration of a terminal device 70 according to the second embodiment can be made substantially similar to the functional configuration of the terminal device 30 according to the first embodiment. Accordingly, the same functional configuration elements as those of the terminal device 30 are denoted by the same reference signs and description thereof will be omitted, and different elements will be described.

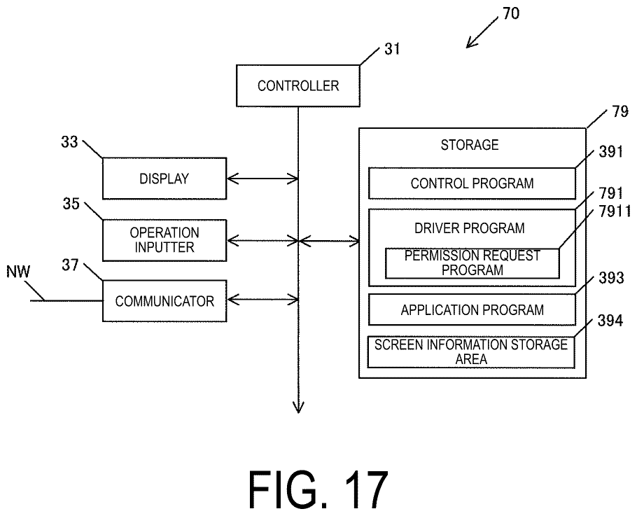

FIG. 17 is a diagram for explaining the functional configuration of the terminal device 70. The terminal device 70 includes a storage 79 instead of the storage 39 of the terminal device 30.

The storage 79 includes a driver program 791 obtained by adding a permission request program 7911 to the configuration of the driver program 392 of the storage 39.

The permission request program 7911 is a program that is read out by the controller 31 when resolving an error related to an error factor received from the multifunction peripheral 50. The controller 31 (printer driver), after reading out the permission request program 7911, performs a necessary process for making a permission request with respect to the administrator of the multifunction peripheral 50 in order to resolve the error related to the error factor.

### 2.2 Procedure

### 2.2.1 Procedure of Terminal Device 70

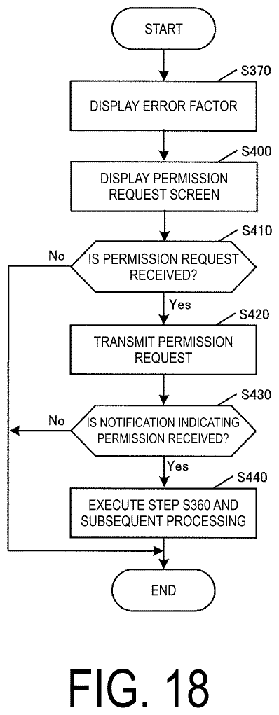

FIG. 18 is a flowchart for explaining a procedure of the terminal device 70. The process explained by the flowchart of FIG. 18 can be executed as part of the process explained by the flowchart of FIG. 6 in the first embodiment. Therefore, the flowchart of FIG. 18 will be described while using the description of the process related to the flowchart of FIG. 6.

In step S370 of FIG. 6, the printer driver displays the error factor received from the multifunction peripheral 50 on the print execution screen, and displays a permission request screen for asking the user whether to make a permission request for resolving the error related to the error factor (step S400).

When a permission request is received from the user via the displayed permission request screen, the printer driver transmits a permission request for resolving the error related to the error factor with respect to the multifunction peripheral 50 (step S410; Yes, then proceed to step S420).

After transmitting the permission request, the printer driver determines whether a notification indicating that the permission request is accepted is received from the multifunction peripheral 50 (step S430). In a case where it is determined that the notification indicating the acceptance of the permission request is received, the printer driver executes step S360 and subsequent processing in FIG. 6 (step S430; Yes, then proceed to step S440).

On the other hand, in a case where a permission request from the user is not received via the displayed permission request screen (step S410; No) or in a case where a notification indicating that the permission request is rejected is received from the multifunction peripheral 50 (step S430; No), the printer driver ends the process.

### 2.2 2 Procedure of Multifunction Peripheral 50

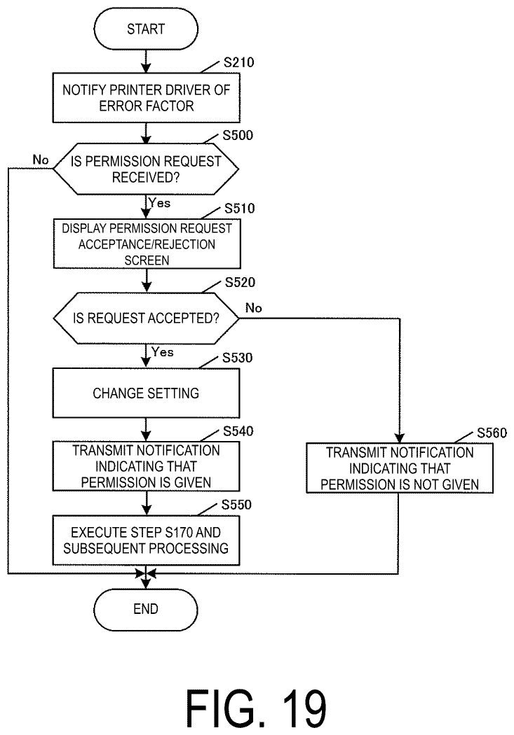

FIG. 19 is a flowchart for explaining a procedure of the multifunction peripheral 50. The process explained by the flowchart of FIG. 19 can be executed as part of the process explained by the flowchart of FIG. 5 in the first embodiment. Therefore, the flowchart of FIG. 19 will be described while using the description of the process related to the flowchart of FIG. 5.

In step S210 of FIG. 5, when an error factor is notified to the printer driver, the controller 11 of the multifunction peripheral 50 determines whether a permission request is received from the printer driver (step S500). When it is determined that the permission request is received from the printer driver, the controller 11 displays a permission request acceptance/rejection screen for inquiring of the administrator whether to accept the request for resolving the error (step S500; Yes, then proceed to step S510).

When an input indicating that the request is accepted is received from the administrator via the displayed permission request acceptance/rejection screen, the controller 11 changes the setting related to the error factor (step S520; Yes, then proceed to step S530). Then, in response to the permission request received from the printer driver, the controller 11 transmits a notification indicating that the permission is given by the administrator to the printer driver (step S540). After transmitting the notification indicating that the permission is given, the controller 11 executes step S170 and subsequent processing in FIG. 5 (step S550).

When the permission request is not received from the printer driver with respect to the notified error factor in step S500 (step S500; No), the controller 11 ends the process.

Further, in step S520, when an input indicating that the permission request is accepted is not received from the administrator via the displayed permission request acceptance/rejection screen, the controller 11 transmits a notification indicating that the permission is not given to the printer driver (step S520; No, then proceed to step S560) and ends the process.

### 2.3 Operation Example

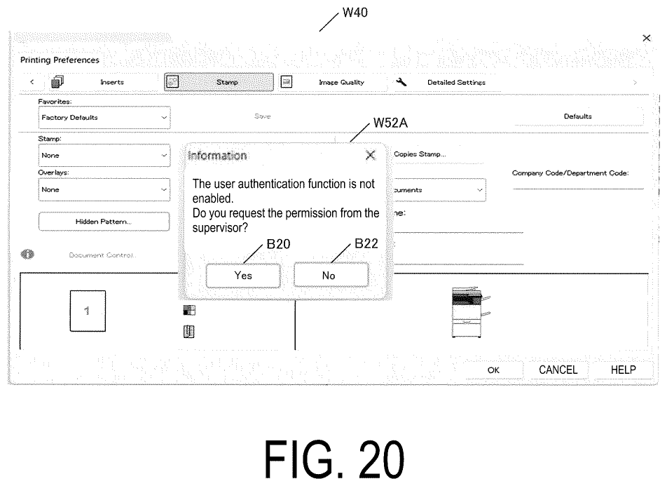

FIG. 20 is a diagram for explaining an example of a permission request screen W52A for asking the user whether to make a permission request for resolving the error. FIG. 20 is an operation example corresponding to the processing related to step S400 in FIG. 18. FIG. 20 illustrates an example in which a message of “The user authentication function is not enabled. Do you request the permission from the administrator?” is displayed on the permission request screen W52A as a content for asking the user whether to issue a permission request.

The permission request screen W52A includes a Yes-button B20 and a No-button B22. The Yes-button B20 is a button for receiving an execution command for the permission request as a response content from the user. The No-button B22 is a button for receiving a cancel command for the permission request by the user. Upon receiving the selection of the Yes-button B20 by the user, the printer driver determines that a permission request has been made by the user, and transmits a permission request for resolving the error with respect to the multifunction peripheral 50.

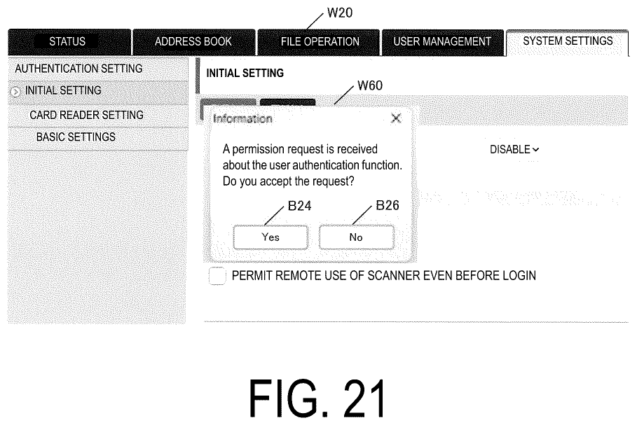

FIG. 21 is a diagram for explaining an example of a permission request acceptance/rejection screen W60 for inquiring of the administrator whether to give the permission for resolving the error. FIG. 21 is an operation example corresponding to the processing related to step S510 in FIG. 19. FIG. 21 illustrates an example in which a message of “A permission request is received about the user authentication function. Do you accept the request?” is displayed on a permission request acceptance/rejection screen W60 as a content for asking the administrator whether to accept the request.

The permission request acceptance/rejection screen W60 includes a Yes-button B24 and a No-button B26. The Yes-button B24 is a button for receiving an execution command of permission request acceptance (setting change) from the administrator for resolving the error.

The No-button B26 is a button for receiving a cancel command of permission request acceptance for resolving the error from the administrator. Upon receiving the selection of the Yes-button B24 from the administrator, the controller 11 determines that the administrator has permitted the resolving of the error related to the error factor, changes the setting of a function related to the error factor (for example, the user authentication function), and transmits a message indicating that the resolving of the error related to the error factor is permitted to the printer driver.

As described above, according to the second embodiment, in addition to the advantageous effects of the first embodiment, even when the provision condition based on the necessary information is not satisfied, a permission request is made with respect to the administrator of the multifunction peripheral, and when the provision condition is satisfied (the error factor is resolved), image information can be transmitted to the multifunction peripheral, whereby an image forming apparatus excellent in convenience can be provided.

The disclosure is not limited to the embodiments described above and can be changed in various manners. In other words, embodiments obtained by combining technical mechanisms appropriately changed without departing from the gist of the disclosure are also included in the technical scope of the disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

As a non-transitory computer readable recording medium storing therein a program in the information processing device, any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like may be used. In this case, since the program recorded in the recording medium is read by a computer of the information processing device and executed by the computer, not only the aforementioned functions of the embodiments are implemented, but also the functions of the disclosure are implemented by performing processes in cooperation with an operating system, another application program, or the like based on the commands of the program.

In a case where the programs are distributed to the market, the programs can be stored and distributed in a portable recording medium, or can be transferred to a server computer connected via a network such as the Internet. In this case, it is a matter of course that the storage device of the server computer is also included in the disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the disclosure can use a new integrated circuit based on the new integrated circuit technology.

### REFERENCE SIGNS LIST

10, 50 Multifunction peripheral
11 Controller
13 Display
15 Operation inputter
17 Communicator
19, 59 Storage
191 Control program
192 Job control program
193 Authentication program
194 Additional information-related program
1941 Image information determination program
1942 Code generation program
1943 Output image information generation program
195 Authentication information storage area
591 Permission program
30, 70 Terminal device
31 Controller
33 Display
35 Operation inputter
37 Communicator
39, 79 Storage
391 Control program
392, 791 Driver program
7911 Permission request program
393 Application program
394 Screen information storage area

1. An image forming apparatus, comprising:
one or more controllers; and
an image former,
wherein when information for giving additional information to image information is included in print job data transmitted from an information processing device, the one or more controllers generate the additional information, and
when the image information is image information related to a document that certifies authenticity of contents and a setting of the image forming device satisfies a provision condition for giving the additional information, the one or more controllers control the image former to give the additional information to the image information and form an image.

2. The image forming apparatus according to claim 1,
wherein when the image information is image information related to a document that certifies authenticity of the contents, the one or more controllers generate the additional information including organization information regarding an organization to which a user who executes a job regarding image formation of the document belongs.

3. The image forming apparatus according to claim 1,
wherein even when the image information is image information related to a document that certifies authenticity of the contents and information for giving the additional information is included in the print job data, the one or more controllers notify the information processing device of an error when a setting of the image forming apparatus does not satisfy the provision condition.

4. The image forming apparatus according to claim 1,
wherein the provision condition is a condition in which a user authentication function is enabled.

5. The image forming apparatus according to claim 3, further comprising:
a permitter that receives input of a response content with respect to a permission request from the information processing device,
wherein the one or more controllers control the image former to form the image when input of a response content indicating that the permission request is accepted is received via the permitter from an administrator having administrative privileges over the image forming apparatus.

6. The image forming apparatus according to claim 2,
wherein the one or more controllers generate the additional information as encoded information, and control the image former to perform the image formation by giving a code based on the encoded information to an image based on the image information.

7. The image forming apparatus according to claim 6,
wherein when the image information is image information related to a document that certifies authenticity of the contents, the one or more controllers generate the encoded information including login information with respect to the image forming apparatus or a character string including data and time information of printing as a content in addition to the organization information, and cause the character string represented by decoding the code to be connected without a delimiter.

8. The image forming apparatus according to claim 6,
wherein when an image forming position of the code overlaps with an image forming position of an image different from the code, the one or more controllers control the image former to perform the image formation while prioritizing the code.

9. A non-transitory computer readable storage medium storing a driver program for causing a computer to enable
a function to display an input screen for receiving input of a print setting related to a print job, and
a function to output print job data including information related to giving additional information to image information received from a user via the input screen and the image information.

10. The non-transitory computer readable storage medium storing a driver program according to claim 9,
wherein the input screen includes a selection screen for receiving a selection of a type of the additional information by the user.

11. The non-transitory computer readable storage medium storing a driver program according to claim 10,
wherein as a type of the additional information for receiving a selection by the user, the selection screen displays any of additional information regarding image information of a document that certifies authenticity of contents, additional information regarding image information of a document different from the document that certifies authenticity of the contents, and no additional information in a selectable manner.

12. The non-transitory computer readable storage medium storing a driver program according to claim 11,
wherein when the additional information regarding the image information of the document that certifies the authenticity of the contents is selected as a type of the additional information, the input screen receives input of the additional information.

13. The non-transitory computer readable storage medium storing a driver program according to claim 12,
wherein the input screen displays an input confirmation button in a non-selectable state until input of the additional information is completed.

14. A printing method in an image forming apparatus, the method comprising:
generating additional information when information for giving the additional information to image information is included in print job data; and
forming an image by giving the additional information to the image information when the image information is image information related to a document that certifies authenticity of contents and a setting of the image forming apparatus satisfies a provision condition for giving the additional information.
